(19) United States
(12) Patent Application Publication
(10) Pub. No.: US 2014/0343991 A1
(43) Pub. Date: Nov. 20, 2014

(54) Method and system for administration of advice using a server connected to a network

(71) Applicant: Engbert Hendrik Hofstee, Brasschaat (BE)

(72) Inventor: Engbert Hendrik Hofstee, Brasschaat (BE)

(21) Appl. No.: 13/896,367

(22) Filed: May 17, 2013

(51) Int. Cl. G06Q 30/06

(52) U.S. Cl. CPC G06Q 30/0601
USPC 705/7.18; 705/7.13

(57) ABSTRACT

A system and related method are disclosed for providing advice as a service offered via a server over a network. Advisor profiles are published with instructions for contacting the advisors, along with working hours or similar information. Advisees, who have profiles of their own, can request advice and be connected to an advisor for a communication session using text, video chat, email, or VoIP. Affiliates can gain commissions for referred advisees, and third-party websites can also host the services the system offers on the back end. Advisors can also give webinars, and attending advisees can ask questions by text.

### TECHNICAL FIELD

Embodiments of the present invention relate generally to the delivery of service via electronic networks, and more particularly to online marketplaces for advice services.

### BACKGROUND ART

The nature of the advice business is changing. New kinds of business organizations are emerging as employees seek greater flexibility through working independently. Large, vertically integrated companies are being replaced by fluid, self-managed groups of diverse individuals who work online from home or small office. The traditional market for services, both online and offline, is highly fragmented. In the offline world, a customer of services has traditionally located services providers through the local telephone directory, print publications or personal referrals. Once a service provider was located, however, the customer had to contact him or her, arrange a method or time to review his or her prior work or otherwise evaluate his or her qualifications for advice and negotiate a price. Even in the age of the Internet, thousands of service providers, both individuals and companies, offer their services, but their individual web sites or online postings are often difficult to find or do not disclose sufficient information regarding the quality of their service, reputation or availability. Furthermore, a customer of services still has to contact each advisor individually through electronic mail (email), personal visit, or telephone and evaluate their qualifications, availability and price on an individual basis. As a result, comparison-shopping, negotiation and collaboration with advisors have traditionally been time-consuming, inefficient and costly for the customer of advice services.

Online marketplaces for physical goods have successfully aggregated vendors and enabled customers to compare prices and make such purchases more efficiently. In contrast to online marketplaces for physical goods, however, traditional online marketplaces for services are significantly more complex because each service is performed on a custom order basis and each end product is unique. The process of creating and delivering a service is more critical than with most products, as the customer and advisor of services must work collaboratively to define the parameters of the project and develop a finished product that meets the specifications of the customer. In addition, unlike in product marketplaces, the lowest cost provider of services is not necessarily the best one for the customer; the customer's decision may not only be based on price, but also on the experience of the advisor, availability, testimonials, and reliability.

The fragmentation of the traditional market for advise services both online and offline has therefore created a strong need for new online advise marketplace that can simplify the access to advisors and provide their advice services via a very efficient manner.

### SUMMARY OF THE EMBODIMENTS

A goal of the disclosed system and method is therefore to offer an online advice provision platform wherein the collective services offering of all advisors is used to optimize their exposure of their services. A further goal of is to deliver advice in an efficient manner using measures including search engine optimization, social media, online advertisement, printed media advertisement, promotion material as flyers, stickers. The disclosed system and method will simplify this process and will help to advisor to management his work and leisure time, by allowing the advisor to set working hours.

According to one embodiment of the method, at least one server connected to a network maintains user account profiles in the memory of the server, including advisor profiles. The advisor profiles include contact instructions. The method also includes publishing the advisor accounts via the network, receiving a request for advice from an advisee, selecting an advisor to complete the request, initiating a session using network communication services between the advisor and advisee, and administering the session.

An additional embodiment of the method involves accepting area of expertise data from an advisor and maintaining the area of expertise data in the advisor profiles. A related embodiment involves receiving verification data from the advisor, and adding data indicating reception of verification data to the advisor profile. Another related embodiment includes the steps of maintaining a list of areas of expertise that require verification and for each area of expertise on that list, maintaining a list of acceptable proofs for verification, and adding the area of expertise data to a given advisor profile only if the advisor submits data consistent with that list of acceptable proofs. According to another embodiment, the user accounts further comprise advisee accounts. Under an additional embodiment, the advisee accounts further comprise a list of favorite advisors. Another embodiment involves maintaining a digital wallet into which the advisee can place money and from which the advisee can withdraw money, and accepting payment from the advisee by deducting money from the advisee's digital wallet. An additional embodiment involves maintaining a digital wallet into which the advisor can place money and from which the advisor can withdraw money, and compensating the advisor for advice by incrementing the balance in the advisor's digital wallet. An additional embodiment has user accounts that include affiliate user profiles, and involves maintaining an affiliate code in each affiliate profile, accepting the affiliate code from an advisee when creating the advisee profile associated with the advisee, and subsequently incrementing the digital wallet of the affiliate profile proportionally to payments from the advisee for advice services. Another embodiment involves accepting customer reviews of advisors, maintaining the reviews in memory accessible to the server, and publishing the reviews via the network.

In another embodiment of the method, the network communication session is a live session, and the method also involves accepting advisor availability data from the advisors, maintaining the advisor availability data as part of the advisor profiles, and initiating sessions of the network communication services with an advisor only if the advisor is available according to the advisor availability data. According to another embodiment, the advisor availability data comprises working hours, and the sessions are initiated only during the working hours. A related embodiment involves accepting advisee messages via the network communication services when the advisor is not available, maintaining the advisee messages in the memory of the server device, and transmitting the advisee messages to the advisor upon the request of the advisor via the network communication services. Another embodiment involves maintaining a maximum wait time in the server memory, requesting consent to initiate session from the selected advisor, determining that the maximum wait time has elapsed after transmitting the invitation to the advisor, determining that the advisor has not yet agreed to initiate the session, selecting an alternate advisor, and transmitting an invitation to initiate communication to the newly selected advisor. Another embodiment involves accepting user input from the advisee indicating the maximum time period and selecting an alternate advisor and transmitting an invitation to initiate communication to the newly selected advisor's client machine only if the advisee has selected an alternate time period.

A related embodiment involves receiving a maximum expenditure amount from an advisee, and preventing the submission of advice for which the advisee expenditures would exceed the maximum amount. In a related embodiment, the advice is administered in written form, and preventing the submission of advice for which advisee expenditures would exceed the maximum amount comprises limiting the quantity of written data the advisor can provide. In another embodiment, payments by the advisee for advice services are calculated on a charge-per-unit of time basis. In still another, payments by the advisee for advice services are calculated on a charge-per-unit of data basis.

Under an additional embodiment of the method, the acceptance of advisee requests further comprises displaying by a third party device of information inviting advisees to initiate advice requests, acceptance by the third party device of advisee requests, and acceptance by the electronic device of the advisee requests from the third party devices, and network communication services are provided to the advisee via the third party device. Another embodiment involves accepting an advisor request to create a live webinar, accepting advisee requests to join the live webinar, receiving video and audio data from the advisor via a client machine connected to the network, and streaming that video and audio data to advisees via client devices connected to the network. A related embodiment involves accepting communications from advisees who are attending the webinar to the advisor via network communication services during the webinar.

Also disclosed is a system. Some embodiments of the system include a server with a processor and memory and connected to a network, a data storage component, executing on the server, and maintaining user account profiles in memory accessible to the server, including advisor profiles that include contact instructions, a processing component executing on the server and selecting an advisor to complete an advisee service request, and a network communication component executing on the server, publishing the advisor accounts to client devices connected to the network, receiving request for advice from an advisee, initiating a session using network communication services between the advisor and advisee, and administering the session.

Other aspects, embodiments and features of the disclosed system and method will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The preceding summary, as well as the following detailed description of the disclosed system and method, will be better understood when read in conjunction with the attached drawings. For the purpose of illustrating the invention, presently preferred embodiments are shown in the drawings. It should be understood, however, that the system and the method are not limited to the precise arrangements and instrumentalities shown.

FIG. 1 is a flow chart illustrating some embodiments of the disclosed method.

FIG. 2 is a schematic diagram illustrating some electronic devices that make up some embodiments of the disclosed system.

FIG. 3 is a schematic diagram illustrating a network computing platform such as those used by some embodiments of the disclosed system.

FIG. 4 is a schematic diagram of some embodiments of the disclosed system.

FIG. 5 is a schematic diagram of some embodiments of the disclosed system.

FIG. 6 is a schematic diagram of some embodiments of the disclosed system.

### DETAILED DESCRIPTION OF SPECIFIC EMBODIMENTS

### Definitions

As used in this description and the accompanying claims, the following terms shall have the meanings indicated, unless the context otherwise requires.

An “electronic device” is defined as including personal computers, laptops, tablets, smart phones, and any other electronic device capable of supporting an application as described herein.

A device or component is “coupled” to an electronic device if it is so related to that device that the product or means and the device may be operated together as one machine. In particular, a piece of electronic equipment is coupled to an electronic device if it is incorporated in the electronic device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the electronic device by shared membership in some network consisting of wireless and wired connections between multiple machines (e.g. a printer in an office that prints documents to computers belonging to that office, no matter where they are, so long as they and the printer can connect to the internet).

“Data entry means” is a general term for all equipment coupled to an electronic device that may be used to enter data into that device. This definition includes, without limitation, keyboards, computer mouses, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure.

An electronic device's “display means” is a device coupled to the electronic device, by means of which the electronic device can display images. Display means include without limitation monitors, screens, television devices, and projectors.

To “maintain” data in the memory of an electronic device means to store that data in that memory in a form convenient for retrieval as required by the algorithm at issue, and to retrieve, update, or delete the data as needed.

“Network communication services” are any services by which an electronic device facilitates communication between two or more persons over a network. Network communication services include without limitation email, short message service (SMS) messaging, instant text messaging and similar textual communication services, audio streaming, video streaming, and voice over internet protocol (VoIP services), transfer control protocol and internet protocol (TCP/IP) communications, hypertext transfer protocol (HTTP) communications, file transfer protocol (FTP) communications, and any other service that transfers data across networks in a manner that could be used for interpersonal communication.

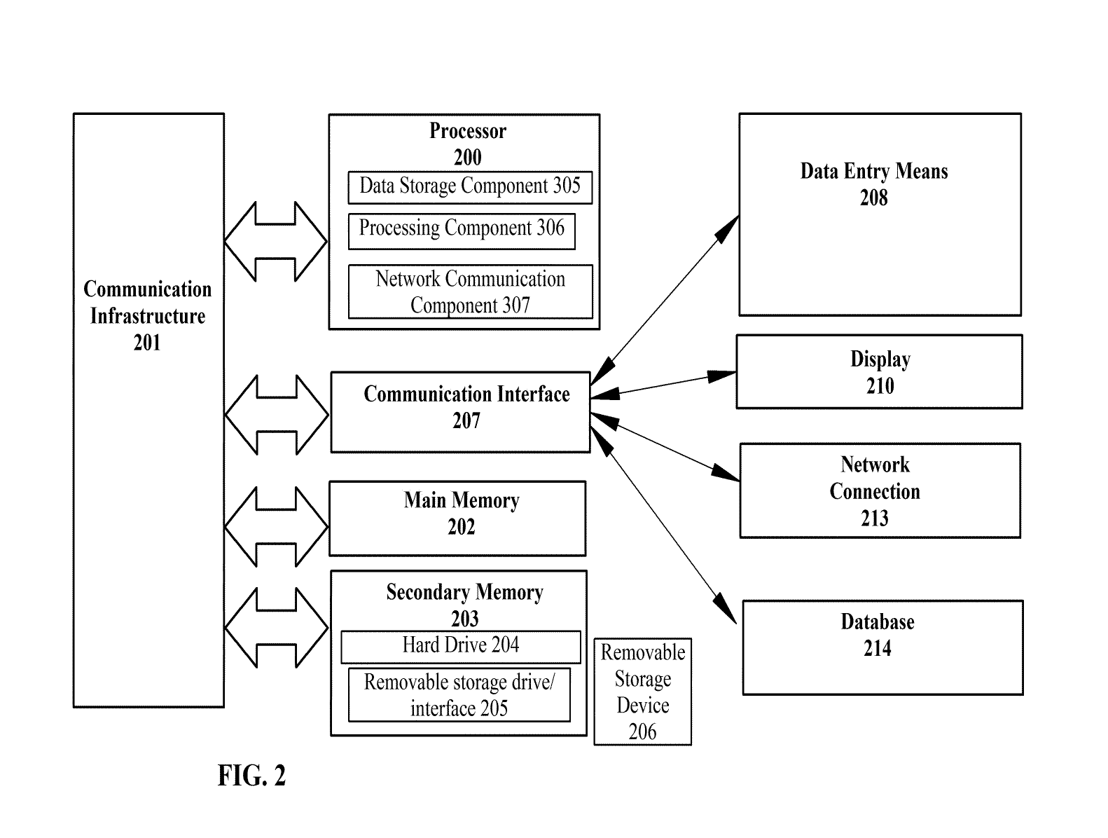

The system and method disclosed herein will be better understood in light of the following observations concerning the electronic devices that support the disclosed application, and concerning the nature of web applications in general. An exemplary electronic device is illustrated by FIG. 2. The processor 200 may be a special purpose or a general purpose processor device. As will be appreciated by persons skilled in the relevant art, the processor device 200 may also be a single processor in a multi-core/multiprocessor system, such system operating alone, or in a cluster of computing devices operating in a cluster or server farm. The processor 200 is connected to a communication infrastructure 201, for example, a bus, message queue, network, or multi-core message-passing scheme.

The electronic device also includes a main memory 202, such as random access memory (RAM), and may also include a secondary memory 203. Secondary memory 203 may include, for example, a hard disk drive 204, a removable storage drive or interface 205, connected to a removable storage unit 206, or other similar means. As will be appreciated by persons skilled in the relevant art, a removable storage unit 206 includes a computer usable storage medium having stored therein computer software and/or data. Examples of additional means creating secondary memory 203 may include a program cartridge and cartridge interface (such as that found in video game devices), a removable memory chip (such as an EPROM, or PROM) and associated socket, and other removable storage units 206 and interfaces 205 which allow software and data to be transferred from the removable storage unit 206 to the computer system.

The electronic device may also include a communications interface 207. The communications interface 207 allows software and data to be transferred between the electronic device and external devices. The communications interface 207 may include a modem, a network interface (such as an Ethernet card), a communications port, a PCMCIA slot and card, or other means to couple the electronic device to external devices. Software and data transferred via the communications interface 207 may be in the form of signals, which may be electronic, electromagnetic, optical, or other signals capable of being received by the communications interface 207. These signals may be provided to the communications interface 207 via wire or cable, fiber optics, a phone line, a cellular phone link, and radio frequency link or other communications channels. The communications interface in the system embodiments discussed herein facilitates the coupling of the electronic device with data entry devices 208, the device's display 210, and network connections, whether wired or wireless 213. It should be noted that each of these means may be embedded in the device itself, attached via a port, or tethered using a wireless technology such as BLUETOOTH®.

Computer programs (also called computer control logic) are stored in main memory 202 and/or secondary memory 203. Computer programs may also be received via the communications interface 207. Such computer programs, when executed, enable the processor device 200 to implement the system embodiments discussed below. Accordingly, such computer programs represent controllers of the system. Where embodiments are implemented using software, the software may be stored in a computer program product and loaded into the electronic device using a removable storage drive or interface 205, a hard disk drive 204, or a communications interface 207.

Persons skilled in the relevant art will also be aware that while any device must necessarily comprise facilities to perform the functions of a processor 200, a communication infrastructure 201, at least a main memory 202, and usually a communications interface 207, not all devices will necessarily house these facilities separately. For instance, in some forms of electronic devices as defined above, processing 200 and memory 202 could be distributed through the same hardware device, as in a neural net, and thus the communications infrastructure 201 could be a property of the configuration of that particular hardware device. Many devices do practice a physical division of tasks as set forth above, however, and practitioners skilled in the art will understand the conceptual separation of tasks as applicable even where physical components are merged.

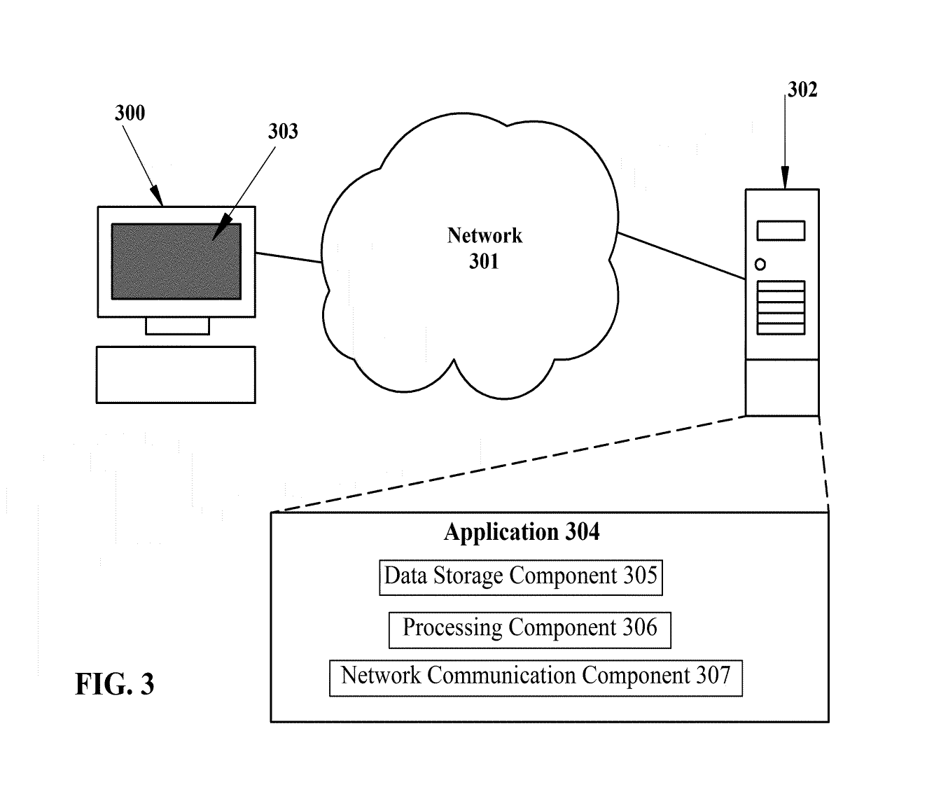

The systems may be deployed in a number of ways, including on a stand-alone electronic device, a set of electronic devices working together in a network, or a web application. Persons of ordinary skill in the art will recognize a web application as a particular kind of computer program system designed to function across a network, such as the Internet. A schematic illustration of a web application platform is provided in FIG. 3. Web application platforms typically include at least one client device 300, which is an electronic device as described above. The client device 300 connects via some form of network connection to a network 301, such as the Internet. The network 301 may be any arrangement that links together electronic devices 300, 302, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 301 is at least one server device 302, which is also an electronic device as described above. Of course, practitioners of ordinary skill in the relevant art will recognize that a web application can, and typically does, run on several server devices 302 and a vast and continuously changing population of client devices 300. Computer programs on both the client device 300 and the server device 302 configure both devices to perform the functions required of the web application 304. Web applications 304 can be designed so that the bulk of their processing tasks are accomplished by the server device 302, as configured to perform those tasks by its web application program, or alternatively by the client device 300. However, the web application must inherently involve some programming on each device.

Many electronic devices, as defined herein, come equipped with a specialized program, known as a web browser, which enables them to act as a client device 300 at least for the purposes of receiving and displaying data output by the server device 302 without any additional programming. Web browsers can also act as a platform to run so much of a web application as is being performed by the client device 300, and it is a common practice to write the portion of a web application calculated to run on the client device 300 to be operated entirely by a web browser. Such browser-executed programs are referred to herein as “client-side programs,” and frequently are loaded onto the browser from the server 302 at the same time as the other content the server 302 sends to the browser. However, it is also possible to write programs that do not run on web browsers but still cause an electronic device to operate as a web application client 300. Thus, as a general matter, web applications 304 require some computer program configuration of both the client device (or devices) 300 and the server device 302 (or devices). The computer program that comprises the web application component on either electronic device's system FIG. 2 configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Finally, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

The system and method described below permits an advisee to choose the advisor that best suits his or her needs quickly and easily, whether the criterion that drives the selection is availability, customer testimonials such as star rankings, advisor credentials, or cost. The advisee is also provided a straightforward and easily manageable way to request and pay for advice. Advisors may use the disclosed method and system to advertise their services, find advisees, and receive compensation for their advice with a minimum of effort. Other websites may also take advantage of the infrastructure provided by this system to provide advice to their own readers.

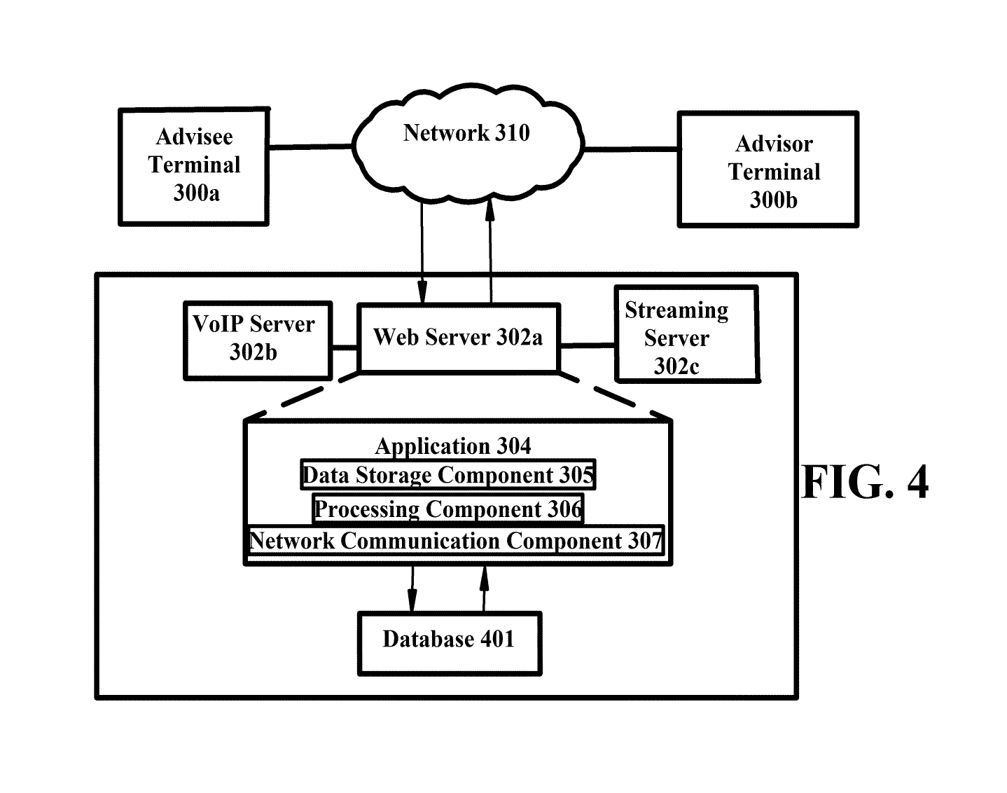

FIG. 4 depicts some embodiments of the disclosed system for online provision of advice services. Embodiments of the system include at least one server device 302a, connected to a network 301. The server 302a may be an electronic device as disclosed above in reference to FIG. 2, or it may be several such devices interconnected and disposed to function together as a unit. The server 302a may be connected to the network 301 in any way discussed above in reference to FIG. 2. The network 301 may be any network as disclosed above in reference to FIG. 3, including the Internet. The server 302 may be operable to deliver advice services via the network 301 by virtue of computer programs, as discussed above in reference to FIG. 2, which combine to create an application 304 operating on the server. The application 304 may be understood by dividing it conceptually into components according to the tasks it performs, specifically a data storage component 305, a processing component 306, and a network communication component 307. This division solely reflects the categorization of tasks that the application 304 must perform, and does not dictate or limit the possible architecture of implementations of the application 304.

In some embodiments, the data storage component 305 maintains user account profiles in memory accessible to the server. Thus, the data storage component 305 may enter the data that makes up a user account into memory when the user account is created. The data storage component 305 may also add information that the user corresponding to the account provides to the system later. The user account data may include an identifier such as a username associated with the user, the user's name, and other information such as the user's date of birth. The user account may correspond to an “advisor,” defined as a person who provides advice via the system, an “advisee,” defined as a consumer of advice provided by the system, an “affiliate,” defined as somebody whom the system compensates for bringing in advisees, or any combination of those three roles. Advisor user accounts in some embodiments include instructions describing how to contact the advisor and data concerning areas of expertise, as set forth in more detail below. Also disclosed in greater detail below, advisee accounts may list preferred advisors, and affiliate accounts may contain a code linking the affiliate to advisees the affiliate induced to try the system. Finally, all account profiles may have a digital “wallet” to which they can electronically transfer money, and from which they can withdraw money; the digital wallets of advisor and affiliate accounts may receive from the system as set forth below in further detail.

The memory in which the data storage component 305 stores user accounts may be the primary memory 202 of the device, or the secondary memory 203, as disclosed above regarding FIG. 2. The memory may also be the memory of an additional device capable of communication with the server, or it may be a database 401. A database 401 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 401, and can be accessed by more complex queries, using languages such as Structured Query Language, which retrieve data based on limiting values passed as parameters and relationships between the data being retrieved. Examples of relational databases include, without limitation, MySQL™ databases and Oracle® databases. A database can be created in any digital memory.

In some embodiments, the processing component 306 selects an advisor to complete an advisee service request, using processes described in more detail below. The processing component 306 also may compare data submitted by advisors purporting to verify advisor credentials to criteria for such verification data, as described below. The processing component 306 also determines whether a requested or selected advisor is available, and calculates whether an attempt to connect with an apparently available advisor has taken too long, as set forth in detail below.

In further embodiments of the system, the network communication component 307 performs tasks for the system that concern passing information over the network 301 as described above. The network communication component 307 provides network communication services. The network communication services used in some embodiments require that the network communication component 307 transmits data to and receives data from client devices 300 used by the communicants. For instance, a video chat session may require that the network communication component 307 stream to an advisee's client terminal 300a audio and video data captured by an advisor's client terminal 300b using a digital camera, while simultaneously streaming similarly-captured audio and video data from the advisee's client machine 300a to that of the advisor. Likewise, email involves receiving textual data and attached data files from one user's client machine 300a via the network 301 and transmitting it to another client machine 300b upon receiving a properly authenticated request. However, under some embodiments, at least one party to the communication may not be interfacing directly with a client device 300. For instance, a VoIP conversation may involve one or all of the parties to the conversation speaking into a conventional telephone, as set forth in more detail below.

In some embodiments, the network communication component 307 uses the provided network communication services to publish the advisor accounts to client devices connected to the network. In additional embodiments, the network communication component 307 receives request for advice from advisees. In response, the network communication component 307 initiates a session using network communication services between the advisor and advisee. The creation of a session involves allocated memory on the server 302a to configure communication so that messages from the instant advisee go to the instant advisor. For instance, a session may be established by creating an instance of a streaming program and populating variables indicating the network addresses of the client machines of the two participants as well as their account information. If the means of communication is email, in contrast, the creation of a session for these purposes may involve simply setting the to and reply-to fields in the email messages, possibly in response to user entries. Finally, the network communication component 307 may administer the session, by passing messages or streaming data between the advisor and the advisee. Each of these tasks will be discussed in more detail below.

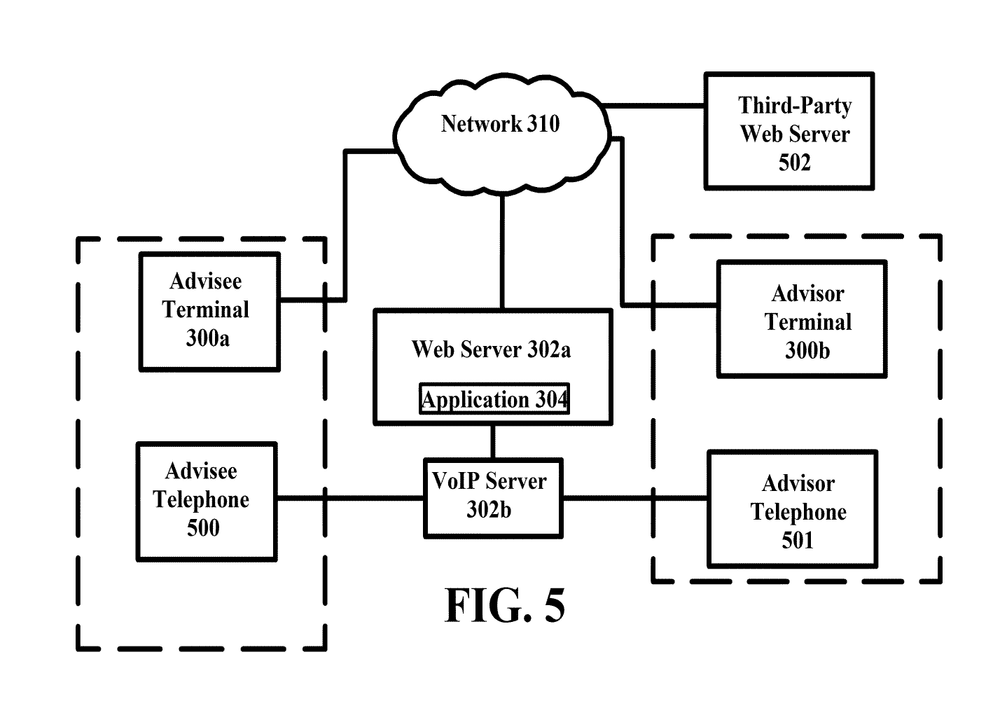

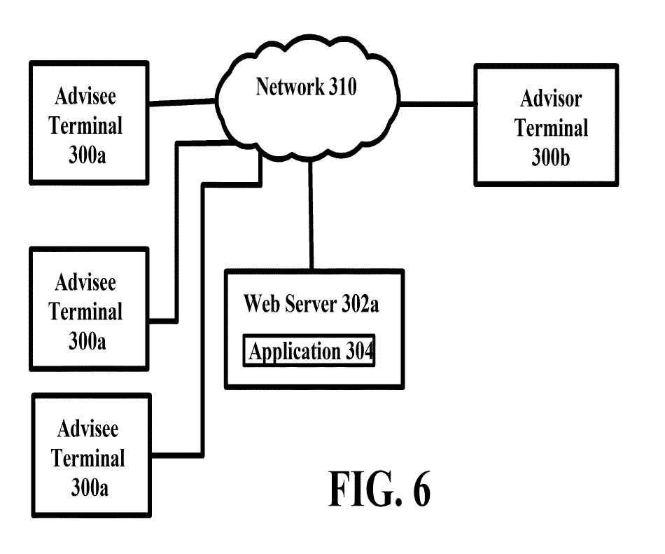

Additional platform configurations used in some embodiments of the method may be better understood by reference to FIGS. 5 and 6. FIG. 5 illustrates communication by VoIP between the advisor and advisee. The server 302a runs the application 304 as before, but the network communication component 307, instead of communicating with a client machine 300a, communicates with the VoIP server 302b, which streams audio to and from the advisee's telephone 500 and the advisor's telephone 501. From the perspective of the advisor and the advisee, the conversation is exactly the same as a conventional telephone conversation. However, the network communication component 307 may also use the VoIP server 302b to transmit options to either telephone so that the advisee and advisor may navigate through the same menu choices as a user of a client machine, for instance using their telephone dialers. FIG. 6 illustrates the ability of the network communication component 307 to transmit communication data to several machines at once. In particular, a single advisor may perform a webinar in which the advisor's input, such as video or audio streaming, is transmitted to several advisee client terminals 300a simultaneously. The advisees in turn may be able to respond with some or all of the network communication services to the advisor client terminal 300b.

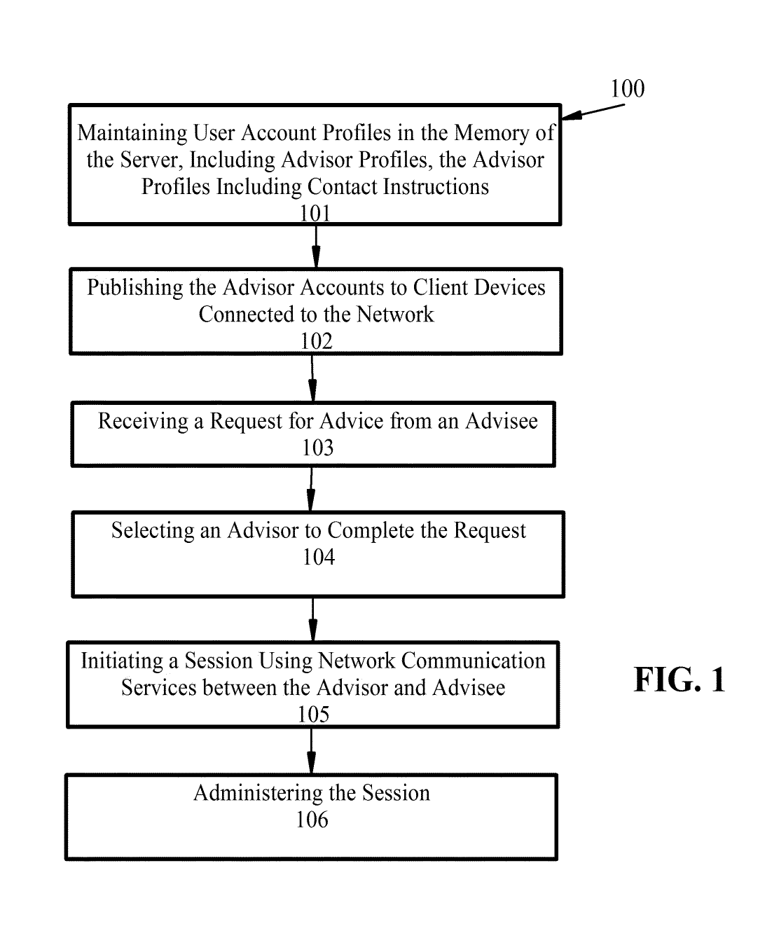

FIG. 1 illustrates some embodiments of a method performed by the system described above in reference to FIGS. 4-6. The method steps may include maintaining user account profiles in the memory of the server, including advisor profiles, the advisor profiles including contact instructions (101). The method also includes publishing the advisor accounts to client devices connected to the network (102). In addition, the method includes receiving a request for advice from an advisee (103). The method further includes selecting an advisor to complete the request; initiating a session using network communication services between the advisor and advisee (104). Finally, the method includes administering the session (105).

Turning to FIG. 1 in more detail, as elucidated by FIGS. 4 and 5, the method involves maintaining user account profiles 101 in the memory of the server 302a. Each user account profile may contain sufficient information to identify the user corresponding to the account, including a name, a username, and geographical information such as an address. The user account may also include authentication information, such as a password or pin, which enables the user to access his or her account. The account information is maintained by the data storage component 305, and may be stored in the memory of the web server 302a or of a database 401 accessible to the web server. In some embodiments, some user profiles are further categorized as advisor profiles, which serve to identify the advisors available for service so that the application 304 can locate them. Advisor profiles also may include contact instructions. Contact instructions are information permitting a person to contact the advisor via the server 302a. Contract instructions may include both contact information, and information about how to navigate to the particular advisor whose profile is being viewed. For instance, an advisor's contact instructions may provide a phone number at which all advisors could be reached via a VoIP server 302b, as well as the sequence of telephone key entries necessary to navigate to the advisor's personal number; alternatively, the contract instructions may specify an extension at which the advisor might be reached. Contact instructions to aid an advisee in setting up a video chat session with an advisor may include a link or Uniform Resource Locator (URL) to which an advisee must navigate, as well as a series of tabs and buttons the advisee must select to initiate the session. Contact instructions may also include email addresses where the medium of communication to be used is email, or screen names for online text chatting services. In addition, the contact instructions may include a personal identification number (PIN), which may be used to contact a specific advisor via any or all of the network communication services. In some embodiments, the advisor profile is published to advisee client terminals 300a along with active controls that allow the advisee to navigate to or connect with the advisor, such as a link or button whose selection automatically sends an advice request to that advisor.

In some embodiments, the data storage component 305 maintains area of expertise data as part of the advisor user profiles. Area of expertise data is data describing fields of knowledge, categories of information, skills, and other matters with which advisors can assist advisees. For instance, in some embodiments area of expertise data could list an advisor's educational and professional background. Other area of expertise data may include special skills such as languages, familiarity with particular computer systems, or the particular topics of study undertaken within the advisor's described field. some embodiments of the method involve receiving verification data from the advisor and adding data indicating reception of verification data to the advisor profile. Verification data may include certificates issued by private or governmental organizations empowered to certify the credentials of a professional in a given field, as well as diplomas, letters of recommendation, writing samples, work-product samples, and any other documentation that helps to demonstrate that an advisor possesses the professed skills, knowledge, or experience. The data added to the advisor profile may be the verification data itself. The data added to the advisor profile may be a message informing the advisees that verification data was received. In some embodiments, the data added to the advisor profile is published with the advisor profile.

In another embodiment, the method involves receiving a request for proof of verification from an advisor, requesting verification data from the advisor, receiving verification data from the advisor, and adding data indicating reception of verification data to the advisor profile. The data added to the advisor profile may be the verification data itself. The data added to the advisor profile may be a message informing the advisees that verification data was received. In some embodiments, the data added to the advisor profile is published with the advisor profile.

In most jurisdictions, there are credentials that are required by law to verify a person's expertise in certain fields. The practice of law and medicine are examples of activities that universally require licenses. To aid in complying with such laws, some embodiments of the method 100 allow advisors to claim certain areas of expertise only if they first provide the credentials required to verify those areas of expertise. A list of areas of expertise that require verification may be maintained in memory accessible to the server 302a by the data storage component 305. The data storage component 305 may also maintain a list of acceptable proofs for verification, such as the proofs required by applicable law, in memory accessible to the server 302a. The processing component 306 may then assess whether an advisor claiming a particular area of expertise has submitted proof that matches acceptable proofs from that list. The degree of sophistication needed to assess the advisor's submission may depend on the kind of proof considered acceptable. If, for instance, the credential is a registration number, as for example an attorney's registration number with a state bar, verification may involve transmitting the submitted number via the network 301 to a server maintained by the state government or a body appointed thereby that maintains the official registry of such numbers. Where the certification is accomplished by a physical or electronic document, the process may be more complex, and may even require in-person examination of physical credentials by a person working with the entity maintaining the server 302a. In some embodiments, such areas of expertise may be added to the advisor's profile only if the advisor has provided acceptable proofs.

The maintenance of user accounts 101 may also include maintaining accounts belonging to advisees. In some embodiments, the existence of advisee accounts permits advisees to track their own history of requests and responses, and to take advantage of network communication services hosted on the server 302a. A particularly useful feature offered in some embodiments is the maintenance in advisee accounts of lists of favorite advisors, allowing advisees to easily select advisors whose services they have enjoyed in the past. The favorites list may be populated by advisee user entries, or created automatically, for instance by the system by tracking the frequency of use of a particular advisor by a particular advisee. The list of favorite advisors may simply list the advisors' user names or other identifying information, or it may provide links to the favored advisors' profiles, or buttons or other event handlers that an advisee could select to initiate a new session with a preferred advisor. The list may be displayed to the advisee when the advisee accesses his or her user profile; where the advisee is connecting by telephone to the VoIP server 302b, the list may be presented aurally, for example, by an electronic voice simulator. In some embodiments, the advisee can give favorite advisors the ability to contact him or her directly to make suggestions or offer additional advice. Some embodiments permit user profiles to contain more than one role, so that an advisor may also be an advisee. For example, a doctor could give medical advice in his or her capacity as a doctor, but then seek legal advice from an attorney who is registered as an advisor.

In some embodiments, the method involves maintaining a digital wallet into which the advisee can place money and from which the advisee can withdraw money, and accepting payment from the advisee by deducting money from the advisee's digital wallet. In some embodiments, the method involves maintaining a digital wallet into which the advisor can place money and from which the advisor can withdraw money, compensating the advisor for advice by incrementing the balance in the advisor's digital wallet. A digital wallet may be any data structure or other means of allocating memory accessible to the server 302a that stores a representation of money, belonging to the user, which is in the custody of the entity that owns or administrates the server 302a. Any user can increase the amount of money represented in the user's digital wallet by increasing the funds placed in the custody of that entity. In some embodiments, the user may increase the money represented in the digital wallet by electronically wiring money to the server 302a or by having the server 302a or a machine in communication with the server process an electronic check or a credit card payment. Some embodiments involve having the user store a payment facility such as a credit card number, bank account and routing number, or an external payment facility such as a PayPal™ account. The user may also decrease the amount of money represented in the digital wallet by having the server 302a transfer money to accounts under the user's control, for instance by making an electronic deposit to the user's bank account, or by posting a credit to the user's credit card account. The amount in the user's digital wallet may also be decremented when the user choses to avail him or herself of services offered by the system, including advice from one of the advisors. For the purposes of simplicity, when a user transfers funds to the custody of the entity so that a representation of those funds appears in the user's digital wallet, the user can be said to have placed or put money into the digital wallet. When a user causes the entity to transfer funds to accounts under the user's control, causing the amount represented in the digital wallet to reduce correspondingly, the user is said to have taken money out of or withdrawn money from the digital wallet. Finally, when the server 302a decrements the digital wallet to pay for a service, it does so by removing a corresponding amount of funds from the possession of the user, so that the user can no longer access those funds, and so that the entity can use them as its own funds. Likewise, when the server 302a increments a user's digital wallet to compensate the user for a service rendered, it makes available corresponding funds, formerly possessed by the entity operating the server 302a that the user will be able to withdraw from the wallet at will. In some embodiments, advisees who do not have digital wallets or advisee accounts may still pay for services by other means. In some embodiments, advisees who pay by those other means pay a different rate than advisees who pay using digital wallets.

In some embodiments, the data storage component 305 also maintains some user accounts as affiliate accounts. An affiliate is a person whom the entity managing the server 400 compensates for expanding the customer base of the system. In some embodiments, the processing component 306 calculates a commission to pay affiliates for revenue generated by advisees the affiliates induced to use the system. The commission may be a percentage of the revenues acquired from each such advisee, it may be a fixed amount per advice session, or it may be a one-time fee paid for each new advisee that may be attributed to the affiliate, among other possibilities. In some embodiments, the affiliate is compensated by having the server 302a place the amount of the calculated compensation in the affiliate's wallet. One way some embodiments link a particular customer to the affiliate that caused the customer to try the system is by programming the data storage component 305 to maintain a code in the affiliate's user profile that an advisee can enter upon creating a new advisee account with the system, and then having the processing component 306 use that code to track the advisee's payments into the system for advice. As before, some embodiments allow user profiles to contain multiple roles; thus, advisors or advisees may also be affiliates. In the former case, advisors who invited advisees to try their advice via the system without establishing an account may be compensated for obtaining the advisees' regular custom. In the latter case, advisees who recommend friends may be compensated for their referral.

The method 100 also includes publishing the advisor via the network 301. A purpose of this step is to allow advisees, whether registered or not, to contact advisors via the server 302a and request their advice. In some embodiments, the network communication component 307 performs this step by transmitting data to be displayed on a web browser or similar universal client program executing on a client device 300. This data may be formatted to shape its display, for instance using hypertext markup language (HTML) or similar approaches. In other embodiments, the network communication component 307 may transmit the data to a specially designed client program, such as an app on a smartphone or tablet. The network communication component 307 may also convey the data in a message, for instance via email, to persons who have subscribed to receiving such messages. Finally, the data may be transmitted to telephones 500 via the VoIP server 302b. The data published for each advisor profile may not be the entire profile. In some embodiments, the data is limited to the advisor's contact instructions and areas of expertise. The data displayed on the client devices 300 may also be filtered or sorted by categories of the data such as the areas of expertise of the advisors listed. This may be accomplished either on the client devices 300 when displaying the data, or by the server 302a when preparing the data to transmit, whether in response to requests by the client or according to internally determined criteria. For instance, an advisee may call into the VoIP server 302b using a telephone 500, and enter responses to prompts or affirmative requests on that telephone 500; the VoIP server 302b may then convey the advisee's selections to the server 302a, where the network communication component 307 filters out advisor profiles not selected by the advisee's inputs, and orders the remaining accounts as specified by the advisee or in a default order found to be useful for most users. The network communication component 307 may then transmit the data to the advisee telephone 500 via the VoIP server 302b, so that the advisee can hear the list of advisors. Similarly, embodiments displaying the advisor profiles on web pages may provide buttons, links, and other controls allowing the advisee to filter and sort profiles, and the data may be formatted either by the server 302b or by the client device 300 to redisplay as dictated by those selections. However the profiles are displayed, they may also include means by which the advisee can initiate contact with the listed advisors, such as links on a web page, buttons on the web page, or numbers to enter on the telephone to cause the processing component 306 to find the selected advisor profile and initiate a session.

Another kind of data that may be published in conjunction with the advisor profiles is customer reviews of advisors. These reviews may be submitted by advisees directly to the server 302a via the network 301, or they may be collected by other persons or entities, such as the entity managing the server 302a. In the former case, some embodiments may accept the reviews as user input on client devices 300, which are subsequently accepted by the network communication component 307 via the network, using web page form submission, email, live messaging, or live streaming services, among others. Other embodiments could involve the network communication component performing an automated telephone survey via the VoIP server 302b. However entered into the system, the reviews are maintained in memory accessible to the server 302a by the data storage component 305. The network communication component 307 may then publish the customer reviews over the network 301 as discussed above. The publication of the customer reviews may also involve aggregating them to produce overall ratings for each advisor; for instance, if part of the survey questions answered by the advisees involve rating some aspect of the advisor's services from 1 to 5, the processing component 306 may calculate an average rating score based on all customer entries. Some embodiments allow the advisee to read each review, or sort or filter the reviews to find the most useful ones for that advisee.

The method 100 also includes receiving a request for advice from an advisee 103. The advisee may submit this request in a number of ways. In some embodiments, the contact instructions for an advisor include a phone number that allows an advisee to call into the VoIP server 302b from any telephone 500. In some embodiments, the advisee locates the advisor in a list of advisors displayed on the advisee's client device 300a in the form of a web page or special purpose mobile app, allowing the advisee to navigate to a particular advisor and request that advisor's advice. The advisee may also send an email to a particular advisor according to some embodiments. In some embodiments, the advisee may send a message to the advisor via an internal messaging system. In some embodiments, the advisor can use any of the above approaches to contact the system without attempting to specify a particular advisor. In that case, the advisee may provide a description of the category of advice needed, or select such a description from a list provided by the network communication component 307. The categories of advice may be organized in some cases according to the areas of expertise offered by advisors.

The method 100 also includes selecting an advisor to complete the request for advice 104. This may be very straightforward where the advisor has already chosen an advisor, for instance by following the advisor's published contact instructions. If the advisee does not request a particular advisor but does select an area of expertise from those offered by advisors available to the server 302a, the data storage component 305 may retrieve a list of advisors whose profile includes that area of expertise. That list may then be presented to the advisee to allow the advisee to select from the list. Alternatively, the processing component 306 may choose one advisor from the list based upon factors such as availability, which is discussed in more detail below, or current workload. Where the advisee has neither selected a particular area of expertise nor a particular advisor, but has described a question or problem, the processing component 306 may engage in a process to guess likely areas of expertise matching the question or problem, for example by matching words from the question or problem with keywords associated with areas of expertise. Once the processing component 306 has made that match, it can proceed to present a list of advisors or a single suggested advisor as described above.

The method 100 further includes initiating a network communication session 105. In some embodiments, this process involves the network communication component 307 transmitting a request to a client machine or telephone belonging to the selected advisor inviting that advisor to communicate with the advisee. If the advisor responds affirmatively, the network communication component 307 will create a new communication session between the advisor and the advisee via one of the network communication services available in that embodiment. The particular choice of network communication service used during the session may depend on such factors as the means used by the advisee to initiate contact, the advisor's preferred means of communication as described in the advisor's user profile, the advisee's preferred means of communication as described in the advisee's user profile, or the immediate expression of a preference by either the advisor or the advisee. In some embodiments, the advisor or advisee can change the means of communication in use, causing the network communication component 307 to switch the conversation to a different network communication service, and in some embodiments, the session can involve more than one network communication service used simultaneously.

Some embodiments permit advisors to specify in their profiles when they are available to give advice via a live network communication session. A live network communication session is one that involves instantaneous communication. Live network communication sessions include without limitation VoIP telephone calls, video chatting sessions, audio chatting sessions, and text chatting sessions such as those used for instant messaging. A live network communication session may be defined as much by the expectations of the communicants as by the technology used; for instance, a text chatting session is distinguishable from an email exchange in part because of the optimized speed with which messages are transmitted from one client machine 300 to another, and in part by the expectation by both parties that a message sent via a text chat will receive a response in a time that is comparable to the response time in an in-person conversation. As a live session requires immediate attention, therefore, advisors cannot engage in a live session unless they are free during a certain block of time to engage in that session. Thus, an advisor may transmit data via the network to the network communication component 307 establishing when the advisor will or will not be available for live communication. The data storage component 305 may maintain this information in memory accessible to the server 302a, and may save it as a calendar representation or in a similarly organized form, in the advisor profile. The advisor may be able to report availability or lack thereof by the hour, minute or day, and may be able in some embodiments to modify this information further to reflect changes to the advisor's schedule, such as the allocation of a particular time period to communicate with an advisee, a sick day, or a vacation, among other possibilities. The network communication component 307 in some embodiments will not initiate a live network communication session during times in which the advisor has indicated that he or she is not available. In some embodiments, the advisor's availability data takes the form of working hours, during which the advisor is disposed to engage in live communication sessions.

Some embodiments of the method 100 handle the problem of advisor inability with further automated solutions. If, in the situations described above, the advisee finds that the advisor is not available to communicate in the desired manner according to the advisor's availability data, some embodiments allow the advisee to leave a message by means of the network communication services offered by the system. The message may be accepted via the network communication component 307 and maintained in memory accessible to the server 302a by the data storage component 305. The advisor may retrieve the message by requesting it via any network communication services, and the network communication component 307 may transmit the message to the advisor. In other embodiments, if the advisor does not agree to initiate a session within a certain amount of time, the processing component 306 may select an alternate advisor to complete the advice session. To accomplish this, the data storage component 305 may maintain a maximum wait time in memory accessible to the server 302a, and the processing component 306 may compare the time that has elapsed since inviting the advisor to join to that maximum wait time. In some embodiments, if the advisor has not agreed to initiate the session within the maximum wait time, the data storage component 305 may retrieve another advisor's profile and the network communication component 307 may invite that advisor to initiate the session, in place of the originally selected advisor. In embodiments wherein the advisors' profiles also contain availability data as described above, the alternate advisor selected may be one whose profile indicates availability. For embodiments in which the advisee has listed favorite advisors, the new advisor may be selected from that list, for instance, in descending order of preference. Some embodiments permit the advisee to input a choice for a maximum wait time via the network 301, which enables the system to record a maximum wait time for each advisee, and wait more or less time prior to reselection based upon advisee preference. Importantly, this may include permitting the advisee to specify that there is no maximum wait time, if the advisee desires the services of a particular advisor at all costs. In some embodiments, the advisee may even set a different maximum wait time for each category of advice, or for each advice request, among other possibilities. Still other embodiments configure the network communication component 307 to transmit a message to the advisee prior to selecting a new advisor. The message informs the advisee that the maximum wait time has elapsed, and asks whether the advisee wishes to switch to a new advisor or keep waiting. The advisee may then input his decision to wait or to switch via the network 301, and the processing component 306 will direct the data storage component 305 to select a new advisor only if the advisee chooses to select a new advisor. In some embodiments, the advisee also may input a preferred new advisor in response to the message, and the processing component 306 may direct in response that the advisor be selected, subject in some embodiments to the preferred advisor's availability. In other embodiments, the processing component 306 selects the new advisor automatically upon the maximum wait time elapsing.

The method 100 also includes administering the network communication session between the advisee and the selected advisor 106. The session, as described above, may simply be some facility whereby the server 302a is able to direct communication from the advisee to the advisor, for as long as both parties desire communication. In some embodiments, the session also specifies the means of communication to be used; for instance, if contact was initiated by telephone via the VoIP server 302b, the session may specify that communication during the session will take place by telephone, using the VoIP server 302b and service. In some embodiments, the advisor, advisee, or both, can specify their preferred means of communication, for one session or in general. In some embodiments, the advisor or advisee or both may switch the session from one communication means to another, so that a session that begins as a phone conversation can continue as a text chat or by email, for instance. In other embodiments, the switch may automatically occur when one or the other of the parties to the session uses a different communication means to continue the communication. The processing component 306 in some embodiments may restrict the forms of communication that the session may use according to the technologies available to the participants. Thus, if the advisee initiated the session by telephone, and has no client machine 300 that has connected the advisee to the system, the processing component 306 may refuse advisor attempts to switch to a communication format that requires the use of an advisee client machine 300.

In some embodiments, the advisee's payment for the advice communication session proceeds in a conventional manner, by charging the advisee's credit card, for instance, or sending the advisee a bill. In other embodiments, payment is withdrawn by the processing component 306 from the advisee's digital wallet. The advisee may be charged per unit of time for some portions of some sessions. An example of charging per unit of time is a charge per minute during a phone call or video chat. The advisee may also be charged per unit of data for some portions of some communication sessions. Units of data may be measured in a number of ways. Where the means of communication involves discrete messages, as in email or instant-messaging technologies, the advisee may be charged per message. Where the means of communication is textual, the advisee could be charged per character, or per word, among other possibilities. Means of communication that involve communication over the network 301 may also be measured in bits or bytes of data transferred, and charged by the bit or byte, or by similar measurements of data. The advisor can add extra costs for investigation, research, documents, files, and other expenses. This payment may be deducted from the wallet continuously throughout the session, or it may be deducted at the end in a lump sum. In either case, the session may terminate when sufficient charges have accrued to exhaust the funds in the digital wallet. Some embodiments involve receiving a maximum expenditure amount from an advisee, and preventing the submission of advice for which the advisee expenditures would exceed the maximum amount. This amount may be placed in escrow, meaning that the user cannot withdraw it or spend it on other advice services until the instant session is finished. In some embodiments, the advice is administered in written form, and preventing the submission of advice for which advisee expenditures would exceed the maximum amount comprises limiting the quantity of written data the advisor can provide.

The session may terminate when that limit is reached. In some embodiments, the network communication component 307 sends the advisee a message when the session is about to reach either the advisee's spending limit or digital wallet balance, so the advisee has the chance to add to either one if he or she wants the session to continue. Some embodiments allow the advisor to provide free initial communication up to some limit in data or time. In some embodiments, the advisor is paid based upon an hourly rate by adding funds to the advisor's digital wallet. In some embodiments, the advisor is paid a percentage of funds received from the advisee, by adding funds to the advisor's digital wallet.

In some embodiments, the session administration 106 is performed in conjunction with a third-party website, through which advisees access advice service and interface with the network communication session during which they receive their advice. When an advisee submits an advice request to the third-party website, the third-party website may relay the request to the network communication component 307, after which the process of advisor selection and session initiation proceeds in the manner described above in reference to steps 101 through 106. The network communication component 307 may also direct the network communication services through the third-party website throughout the session. As a result, the advisee may interface only with the third-party website, while the system that is performing the advice services does so entirely in the background. This option may be sold to proprietors of third-party websites as a way to elevate their customers' experiences. The third-party website may have a user account stored in memory accessible to the server 302a, using the data storage component 305. If the third-party website is providing advice in its own right and using the system as a “back office” resource, the third-party website may act as an advisor from the perspective of the server 302a and receive compensation for the advice income generated when an advisee receives services via the third-party website. The third-party website may also act essentially as a virtual advisee, in that it routes advice requests from advisees, along with data pertaining to those requests, to advisors via the server 302a, and pay the administrator of the server to convey advice back to the advisee via the third-party website. The third-party website may also work as an affiliate, receiving a percentage of advisee spending that the third-party website directed to the system.

Some embodiments of the method 100 include allowing advisors to conduct live webinars, in which an advisor teaches one or many advisees in a virtual class provided via the network communication services administered by the network communication component 307. The network communication component 307 may accept a request from an advisor to create a live webinar. The webinar thus created may be advertised to advisees via a web page, by email announcements, or by other means that use the network communication services to disseminate information to persons whom it might interest. The advertisement could be directed by the processing component 306 to advisees who have sought advice on related topics in the past, or to advisees who subscribed to receiving news of upcoming webinars on a particular set of topics. Advisees can request, via the network 301, to join the webinar; the network communication component 307 may then create a network communication session in which the advisor administering the webinar and the advisees who have joined are participants. During the live webinar, the advisor's client machine 300 or telephone may accept the advisor's inputs and stream or transmit them to the server 302a, where the network communication component streams or transmits them to each advisee who has joined the webinar, simultaneously. In some embodiments, the advisees may communicate with the advisor during the webinar via the network communication services; for instance, the advisees could submit questions in a textual form which the network communication component 307 could transmit to a client machine 300 the advisor is using, so that the advisor can read the questions on the screen and address them as appropriate during the webinar. The communication may also be audio or video streaming, turning the webinar into a discussion-based class rather than a lecture.

It will be understood that the method or system may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A method for providing expert advice electronically, performed by at least one server connected to a network, comprising:
maintaining user account profiles in the memory of the server, including advisor profiles, the advisor profiles including contact instructions;
publishing the advisor profiles via the network;
receiving a request for advice from an advisee;
selecting an advisor to complete the request;
initiating a session between the advisor and advisee using network communication services; and
administering the session.

2. A method according to claim 1 further comprising accepting area of expertise data from an advisor and maintaining the area of expertise data in the advisor profiles;

3. A method according to claim 2 further comprising:
receiving verification data from the advisor; and
adding data indicating reception of verification data to the advisor profile.

4. A method according to claim 2 further comprising:
maintaining a list of areas of expertise that require verification; and
for each area of expertise on the list:
maintaining a list of acceptable proofs for verification; and
adding the area of expertise data to a given advisor profile only if the advisor submits data consistent with the list of acceptable proofs.

5. A method according to claim 1 wherein the user accounts further comprise advisee accounts.

6. A method according to claim 5 wherein the advisee accounts further comprise a list of favorite advisors.

7. A method according to claim 5 further comprising:
maintaining a digital wallet into which the advisee can place money and from which the advisee can withdraw money; and
accepting payment from the advisee by deducting money from the advisee's digital wallet.

8. A method according to claim 1 further comprising:
maintaining a digital wallet into which the advisor can place money and from which the advisor can withdraw money; and
compensating the advisor for advice by incrementing the balance in the advisor's digital wallet.

9. A method according to claim 1 wherein the user accounts further comprise affiliate user profiles, and further comprising:
maintaining an affiliate code in each affiliate profile;
accepting the affiliate code from an advisee when creating the advisee profile associated with the advisee; and
paying the affiliate an amount based on activity by the advisee.

10. A method according to claim 1 further comprising:
accepting customer reviews of advisors;
maintaining the reviews in memory accessible to the server; and
publishing the reviews via the network.

11. A method according to claim 1 wherein the network communication session is a live session, and further comprising:
accepting advisor availability data from the advisors;
maintaining the advisor availability data as part of the advisor profiles; and
initiating sessions of the network communication services with an advisor only if the advisor is available according to the advisor availability data.

12. A method according to claim 11, wherein the advisor availability data comprises advisor working hours, and the sessions are initiated only during the advisor working hours.

13. A method according to claim 11 further comprising:
accepting advisee messages via the network communication services when the advisor is not available;
maintaining the advisee messages in the memory of the server device; and
transmitting the advisee messages to the advisor upon the request of the advisor via the network communication services.

14. A method according to claim 1 further comprising:
maintaining a maximum wait time in the server memory;
requesting consent to initiate the session from the selected advisor;
determining that the maximum wait time has elapsed after transmitting the invitation to the advisor;
determining that the advisor has not yet agreed to initiate the session;
selecting an alternate advisor; and
transmitting an invitation to initiate communication to the newly selected advisor's client machine.

15. A method according to claim 14 further comprising:
accepting user input from the advisee indicating the maximum time period; and
selecting an alternate advisor and transmitting an invitation to initiate communication to the newly selected advisor's client machine only if the advisee has selected an alternate time period.

16. A method according to claim 1 further comprising:
receiving a maximum expenditure amount from an advisee; and
preventing the submission of advice for which the advisee expenditures would exceed the maximum amount.

17. A method according to claim 16 wherein the advice is administered in written form, and wherein preventing the submission of advice for which advisee expenditures would exceed the maximum amount comprises limiting the quantity of written data the advisor can provide.

18. A method according to claim 1 wherein payments by the advisee for advice services are calculated on a charge-per-unit of time basis.

19. A method according to claim 1 wherein payments by the advisee for advice services are calculated on a charge-per-unit of data basis.

20. A method according to claim 1, wherein:
the acceptance of advisee requests further comprises displaying by a third party device of information inviting advisees to initiate advice requests,
acceptance by the third party device of advisee requests, and acceptance by the electronic device of the advisee requests from the third party devices; and
network communication services are provided to the advisee via the third party device.

21. A method according to claim 1 further comprising:
accepting an advisor request to create a live webinar;
accepting advisee requests to join the live webinar;
receiving video and audio data from the advisor via a client machine connected to the network; and
streaming the video and audio data to advisees via client devices connected to the network.

22. A method according to claim 21, further comprising:
accepting communications from the advisees who are attending the webinar to the advisor via network communication services during the webinar.

23. A system for providing expert advice electronically, the system comprising:
a server connected to a network, the server having a processor and a memory;
a data storage component, executing on the server, and maintaining user account profiles in memory accessible to the server, including advisor profiles, the advisor profiles including contact instructions;
a processing component executing on the server and selecting an advisor to complete an advisee service request; and
a network communication component executing on the server, publishing the advisor accounts to client devices connected to the network, receiving request for advice from an advisee, initiating a session using network communication services between the advisor and advisee, and administering the session.
